(19) United States
(12) Patent Application Publication
(10) Pub. No.: US 2016/0301861 A1
(43) Pub. Date: Oct. 13, 2016

(54) IMAGING DEVICE AND SHOOTING METHOD

(71) Applicant: NUBIA TECHNOLOGY CO., LTD., Shenzhen, Guangdong (CN)

(72) Inventor: Lei MIAO, Shenzhen (CN)

(21) Appl. No.: 15/036,759

(22) PCT Filed: Nov. 7, 2014
(86) PCT No.: PCT/CN2014/090660

§ 371 Date: May 13, 2016

(30) Foreign Application Priority Data
Nov. 15, 2013 (CN) 201310574744.X

(51) Int. Cl. H04N 5/232; H04N 5/262; H04N 5/235

(52) U.S. Cl. CPC H04N 5/23232; H04N 5/23212; H04N 5/23216; H04N 5/2356; H04N 5/23293; H04N 5/2621; H04N 2101/00

(57) ABSTRACT

Disclosed are a shooting method and an imaging device. The shooting method comprises the steps of: after a shooting instruction is received, continuously shooting images of at least two ranges of depth of field, wherein at least one image is shot in each range of depth of field; synthesizing all the shot images into one image file and displaying same; according to an operation instruction from a user, determining focusing region(s), and selecting an image with the clearest focusing region from the image file; according to the selected image, generating a picture and storing same, wherein when there is one focusing region, a picture is directly generated by one image which is selected; and when there are a plurality of focusing regions, a plurality of images which are selected are synthesized so as to generate one picture with focusing regions which are all the clearest. Thus, shooting first and focusing afterwards are realized. Moreover, a user is allowed to select a plurality of focusing regions, and is allowed to conduct fuzzy processing on other regions except the focusing regions, thereby obtaining photographs having special artistic effects, satisfying the user's creative demands, and greatly improving the user experience.

### TECHNICAL FIELD

The disclosure relates to the field of photographic techniques, particularly to a shooting method and an imaging device.

### BACKGROUND

At present, a light field camera has emerged with the rapid development of photographic techniques. The light field camera is able to capture data of light beams of all directions, thus allowing a user to shoot a picture first, and select a focus area subsequently so that pictures of various effects may be obtained as required by the user. However, existing light field cameras are still in early stages, technologies are not mature enough, cost is relatively high, and shooting effects are unsatisfactory, thus user requirements can be hardly satisfied.

### SUMMARY

The disclosure is intended to provide a shooting method and an imaging device, and the disclosure aims to use another method to implement focusing after shooting, thus improving shooting effects and satisfying individual requirements of users.

To this end, the disclosure provides a shooting method, including the following steps:

upon reception of a shooting instruction, images with at least two depths of field are shot continuously, in which: at least one image is shot with each of the at least two depths of field;

all shot images are formed into an image file, and the image file is displayed;

a focus area is determined according to an operation instruction from a user, and an image with the focus area being the clearest is selected from the image file; and

a picture is generated according to the selected image and the generated picture is stored, in which: when there is one focus area, the picture is directly generated from the selected image, and when there is a plurality of focus areas, a plurality of selected images are formed so as to generate a picture with each of the focus areas being the clearest.

In an embodiment, the step that the focus area is determined according to the operation instruction from the user may include that: an area of the image file touched or clicked by the user is determined as the focus area.

In an embodiment, the method may further include: after the step that the image with the focus area being the clearest is selected from the image file, other areas except the focus area of the selected image are blurred.

In an embodiment, the operation instruction may be an instruction for comprehensive forming, and the step that the focus area is determined according to the operation instruction from the user and the image with the focus area being the clearest is selected from the image file may include:

all areas covering the image file is determined as the focus area according to the instruction for comprehensive forming, and all images in the image file are selected.

The disclosure further provides a shooting method, including the following steps:

upon reception of a shooting instruction, at least two images with at least two depths of field are shot continuously, and the at least two images are formed into an image group;

an image of or an image formed from the at least two images is displayed as a preview image for a user to select a focus area; and

the focus area is determined according to an operation instruction from the user, an image with the focus area being the clearest is selected from the image group, and a picture is generated from the selected image.

In an embodiment, the operation instruction may include an instruction of performing focusing on the preview image, and the step that the focus area is determined according to the operation instruction from the user may include:

an operation instruction of touching or clicking on the preview image by the user is taken as the instruction of performing focusing on the preview image, and a touched or clicked area of the preview image is determined as the focus area according to the instruction.

In an embodiment, the method may further include: after the step that the image with the focus area being the clearest is selected from the image group, other areas except the focus area of the selected image are blurred.

In an embodiment, there may be at least two said focus areas, and accordingly, there may be at least two selected images, and the step that the picture is generated from the selected image may include:

the at least two selected images are formed into a picture with each of the at least two focus areas being the clearest.

In an embodiment, the operation instruction may include an instruction of performing comprehensively forming on the images, and the step that the focus area is determined according to the operation instruction from the user may include:

upon reception of the instruction of performing comprehensively forming on the images, all areas covering the preview image are determined as the focus area.

The disclosure provides an imaging device at the same time, including a receiving module, a shooting module and a displaying module, in which:

the receiving module is configured to receive a shooting instruction and an instruction of operating an image file;

the shooting module is configured to continuously shoot at least two images with at least two depths of field, form the at least two images into an image file, and generate a picture according to the instruction of operating the image file; and

the displaying module is configured to display the image file.

In an embodiment, the imaging device may include a processing unit, the instruction of operating the image file may include an instruction of performing focusing on the image file, and the processing unit may be configured to:

after receiving the instruction of performing focusing on the image file, determine a focus area on the image file according to the instruction;

select an image with the focus area being the clearest from the image file; and

generate a picture from the selected image.

In an embodiment, the processing unit may be further configured to: blur other areas except the focus area of the selected image.

In an embodiment, the processing unit may be configured to determine at least two focus areas, select at least two images accordingly, and form the at least two selected images into a picture with each of the at least two focus areas being the clearest.

In an embodiment, the instruction of operating the image file may include an instruction of comprehensively forming the image file, and the processing unit may be configured to, after receiving the instruction of comprehensively forming the image file, form all images in the image file into a picture with each area being the clearest.

The disclosure further provides a shooting method, including the following steps:

upon reception of a shooting instruction, images with a plurality of depths of field are shot continuously, in which: at least one image is shot with each of the plurality depths of field;

a preview image is displayed for a user to determine a focus area;

the focus area is determined according to an instruction from the user;

an image with the focus area being the clearest is selected from the images; and

a picture is generated according to the selected image and stored, in which: when there is one focus area, the picture is directly generated by the selected image, and when there are a plurality of focus areas, a plurality of selected images are formed so as to generate a picture with each of the focus areas being the clearest.

In an embodiment, the step that the focus area is determined according to the instruction from the user may include:

a focus area selecting pattern is generated on the preview image for the user to select one or more focus areas; and

the focus area is determined according to selection by the user.

In an embodiment, the step that the picture is generated according to the selected image may further include:

other areas except the focus area are blurred.

In an embodiment, the step that the focus area is determined according to the instruction form the user may include:

upon reception of an instruction of performing comprehensively forming on the images, all areas covering the preview image are determined as the focus area.

According to a shooting method provided by the disclosure, images with at least two depths of field are shot continuously, and the shot images are formed into an image file to be previewed by a user, then the user is not only allowed to select any focus area on the image file to perform focusing after shooting to generate a satisfactory picture, which implements focusing after shooting with another method, but also allowed to comprehensively form the image file to generate a picture with each of focus areas being the clearest and finally obtain a clear photograph having an artistic effect, so that requirements of self-determination and individual requirements of the user can be satisfied. The disclosure also allows the user to select a plurality of focus areas, and blur other areas except the focus areas, thereby obtaining photographs having special artistic effects, satisfying the user's creative demands, and greatly improving the user experience.

### BRIEF DESCRIPTION OF THE DRAWINGS

FIG. 1 is a flowchart of a shooting method according to a first embodiment of the disclosure;

FIG. 2 is a flowchart of a shooting method according to a second embodiment of the disclosure;

FIG. 3 is a flowchart of a shooting method according to a third embodiment of the disclosure;

FIG. 4 is a flowchart of a shooting method according to a fourth embodiment of the disclosure;

FIG. 5 is a structural block diagram of an imaging device according to an embodiment of the disclosure; and

FIG. 6 is a structural block diagram of a shooting module in FIG. 5.

Implementation of the purpose of the disclosure, and functional features and advantages of the disclosure will be further described in combination with embodiments and with reference to the accompanying drawings.

### DETAILED DESCRIPTION

It should be understood that the specific embodiments described herein are only used for explaining the disclosure, but are not used for limiting the disclosure.

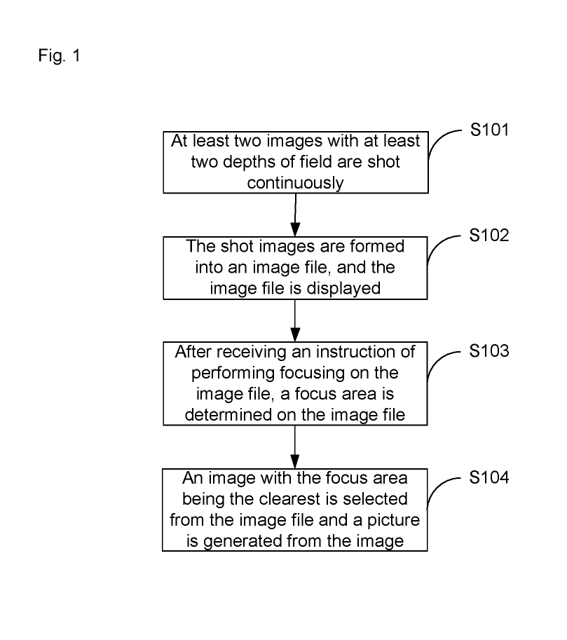

Referring to FIG. 1, the first embodiment of a shooting method of the disclosure is proposed, and the shooting method includes the following steps.

Step S101, at least two images with at least two depths of field are shot continuously.

After receiving a shooting instruction (e.g. a shooting button is pressed), an imaging device drives a camera thereof to move forwards or backwards to shoot at least two images with at least two depths of field continuously. In other words, at least one image is shot with each of the at least two depths of field. The camera is driven by a driving device such as a motor of the imaging device. After being calibrated, a motion parameter of the motor corresponds to a depth-of-field table of the imaging device, and the motor moves by a number of steps or revolutions to drive the camera to move to a corresponding position so as to shoot an image with a corresponding depth of field. The number of depths of field, with which images are shot, may be adjusted as required by a user. For example, images with two depths of field, images with a plurality of depths of field, or even images with all depths of field may be shot. At least one image is shot with each of the at least two depths of field, and it may be also set to shoot two or more images as required by the user.

Step S102, the shot images are formed into an image file, and the image file is displayed.

The image file is a preview image formed by at least two images, and is presented in a preview window of the imaging device for the user to view and operate the image file.

In other words, the image file is an image group formed by a plurality of shot images and composite images thereof, and an image or a composite image is selected as a preview image from the image group for the user to select a focus area.

Step S103, after receiving an instruction of performing focusing on the image file, a focus area is determined on the image file.

The imaging device receives, in real time, a user-triggered operation instruction on the image file and executes the same. The operation instruction on the image file includes an instruction of performing focusing on the image file, an instruction of comprehensively forming the image file and so on. For a touch screen, the user may trigger, by a gesture including touching or clicking on the image file etc. on the screen, the instruction of performing focusing on the image file, then the imaging device determines a touched or clicked area of the image file as a focus area. For a non-touch screen, the instruction of performing focusing on the image file may be also triggered by a functional key or invoking a menu, then a selection pattern is generated on the image file for the user to select a focus area through a button, and the imaging device then uses an area where the selection pattern locates as the focus area.

In some embodiments, the imaging device receives, in real time, a user-triggered instruction of operating a preview image and executes the same. The instruction of operating the preview image includes an instruction of performing focusing on the preview image, an instruction of performing comprehensively forming on the images and so on. For a touch screen, the user may trigger, by a gesture including touching or clicking on the preview image etc. on the screen, the instruction of performing focusing on the preview image, then the imaging device determines a touched or clicked area of the preview image as a focus area. For a non-touch screen, the instruction of performing focusing on the preview image may be also triggered by a functional key or invoking a menu, then a selection pattern is generated on the preview image for the user to select a focus area through a button, and the imaging device then uses an area where the selection pattern locates as the focus area.

Step S104, an image with the focus area being the clearest is selected from the image file and a picture is generated from the image.

The imaging device compares and calculates a plurality of images in the image file, selects an image with the focus area being the clearest, and then generates a picture from the image so as to obtain a photograph with the best effect.

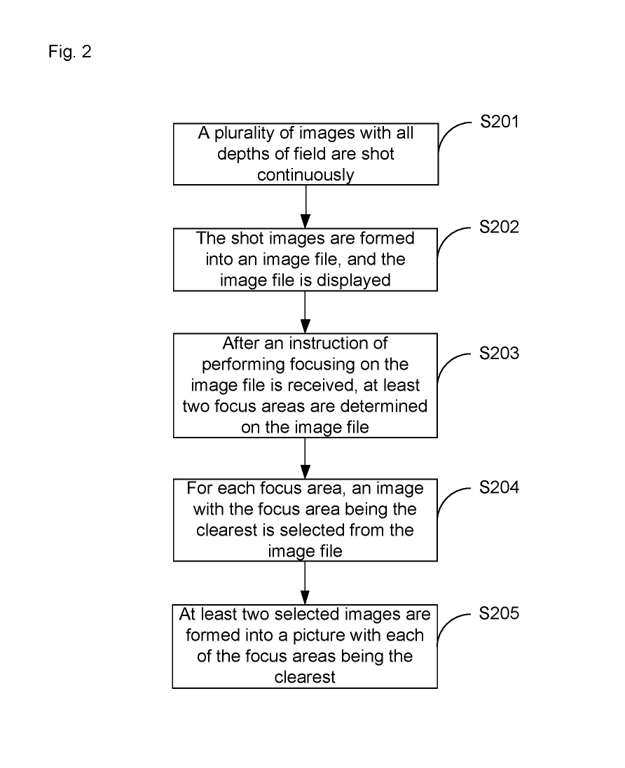

Referring to FIG. 2, the second embodiment of a shooting method of the disclosure is proposed, and the shooting method includes the following steps.

Step S201, a plurality of images with all depths of field are shot continuously.

After receiving a shooting instruction (e.g. a shooting button is pressed), an imaging device drives a camera thereof to move forwards or backwards to shoot a plurality of images with all depths of field continuously. At least one image is shot with each of all depths of field, and it may be also set to shoot two or more images as required by a user. The camera is driven by a driving device such as a motor of the imaging device. After being calibrated, a motion parameter of the motor corresponds to a depth-of-field table of the imaging device, and the motor moves by a number of steps or revolutions to drive the camera to move to a corresponding position so as to shoot an image with a corresponding depth of field.

Step S202, the shot images are formed into an image file, and the image file is displayed.

The image file is a preview image formed by the plurality of images. The preview image is an image randomly selected from the plurality of images in the image file, and presented in a preview window of the imaging device for the user to view and operate the preview image. The remaining images are hidden so that they can be invoked at any time subsequently.

In other words, the image file is an image group formed by the plurality of shot images and composite images thereof, and an image or a composite image is selected as a preview image from the image group for the user to select a focus area.

Step S203, after an instruction of performing focusing on the image file is received, at least two focus areas are determined on the image file.

The imaging device receives, in real time, a user-triggered operation instruction on the image file and executes the same. The operation instruction on the image file includes an instruction of performing focusing on the image file, an instruction of comprehensively forming the image file and so on. For a touch screen, the user may trigger, by directly touching or clicking on the image file, the instruction of performing focusing on the image file, then the imaging device determines touched or clicked areas of the image file as focus areas. For a non-touch screen, the instruction of performing focusing on the image file may be also triggered by a functional key or invoking a menu, then a selection pattern is generated on the image file for the user to select focus areas through a button, and the imaging device then uses areas where the selection pattern locates as the focus areas. The present embodiment allows the user to select at least two focus areas, and the user may select two or more focus areas as required.

In some embodiments, the imaging device receives, in real time, a user-triggered instruction of operating a preview image and executes the same. The instruction of operating the preview image includes an instruction of performing focusing on the preview image, an instruction of performing comprehensively forming on the images and so on. For a touch screen, the user may trigger, by a gesture including touching or clicking on the preview image etc. on the screen, the instruction of performing focusing on the preview image, then the imaging device determines touched or clicked areas of the preview image as focus areas. For a non-touch screen, the instruction of performing focusing on the preview image may be also triggered by a functional key or invoking a menu, then a selection pattern is generated on the preview image for the user to select focus areas through a button, and the imaging device then uses areas where the selection pattern locates as the focus areas. The user may select two or more focus areas as required.

Step S204, for each focus area, an image with the focus area being the clearest is selected from the image file.

The imaging device compares and calculates the plurality of images in the image file, and for each focus area, selects an image with the focus area being the clearest. For example, the user selects 3 focus areas, i.e. focus area 1, focus area 2 and focus area 3, in total, then the imaging device correspondingly selects 3 images in total, i.e. image 1 which is the clearest at focus area 1, image 2 which is the clearest at focus area 2, and image 3 which is the clearest at focus area 3.

Step S205, at least two selected images are formed into a picture with each of the focus areas being the clearest.

The imaging device generates a picture from at least two selected images, thereby obtaining a picture with at least two focus areas being the clearest, and the picture has a special artistic effect.

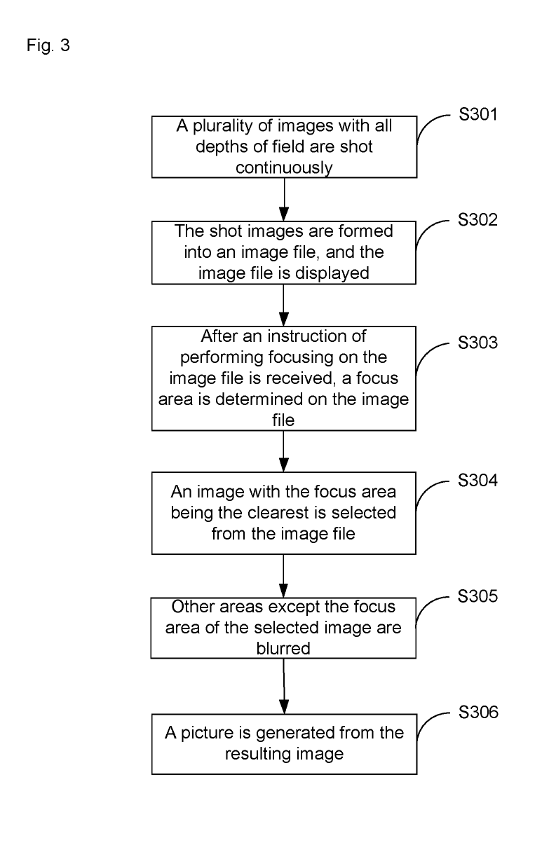

Referring to FIG. 3, the third embodiment of a shooting method of the disclosure is proposed, and the shooting method includes the following steps.

Step S301, a plurality of images with all depths of field are shot continuously.

Step S302, the shot images are formed into an image file, and the image file is displayed.

Step S303, after an instruction of performing focusing on the image file is received, a focus area is determined on the image file.

Step S304, an image with the focus area being the clearest is selected from the image file.

Step S305, other areas except the focus area of the selected image are blurred.

Step S306, a picture is generated from the resulting image.

After other areas except the focus area are blurred, the image in the focus area may be displayed in a more highlighted manner, thus obtaining a picture having an artistic effect.

Besides, the plurality of selected images in the second embodiment can also be blurred in the same way so that a picture which is generated finally not only has a plurality of clear focus areas, but also has other blurred areas except the plurality of focus areas, thereby displaying an image having a plurality of focus areas in a highlighted manner, and obtaining a photograph having a special artistic effect.

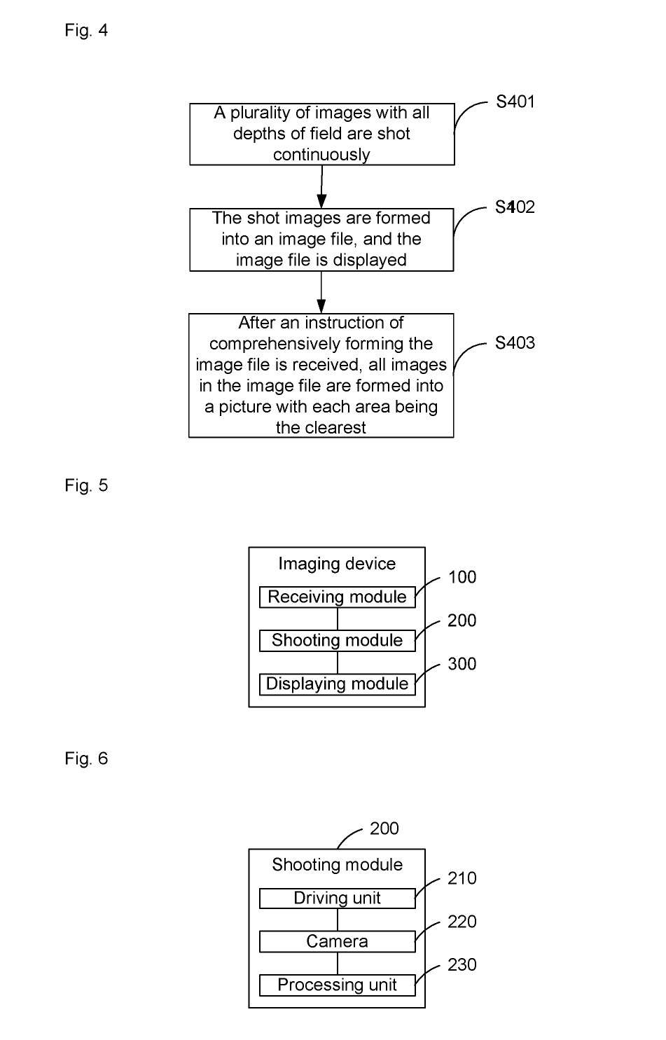

Referring to FIG. 4, the fourth embodiment of a shooting method of the disclosure is proposed, and the shooting method includes the following steps.

Step S401, a plurality of images with all depths of field are shot continuously.

Step S402, the shot images are formed into an image file, and the image file is displayed.

Step S403, after an instruction of comprehensively forming the image file is received, all images in the image file are formed into a picture with each area being the clearest.

An imaging device receives, in real time, a user-triggered operation instruction on the image file and executes the same. The operation instruction on the image file includes an instruction of performing focusing on the image file, an instruction of comprehensively forming the image file and so on. For a touch screen, the instruction of comprehensively forming the image file may be triggered by a gesture including swiping on the screen, long pressing, or clicking on the image file and so on. For a non-touch screen, the instruction of comprehensively forming the image file may be also triggered by a functional key or invoking a menu, then the imaging device comprehensively forms the image file so as to form all images in the image file into a picture which are the clearest in all areas.

After receiving the instruction of performing comprehensively forming on the images, the imaging device determines all areas covering a preview image as focus areas, and then forms all images in an image group into a picture with all areas being the clearest.

In the first embodiment to the fourth embodiment, an image file may be operated repeatedly to generate a plurality of pictures having various effects, and the image file may also be stored, and invoked at any time to be operated to generate a picture.

According to a shooting method provided by the disclosure, images with at least two depths of field are shot continuously, and the shot images are formed into an image file to be previewed by a user, then the user is not only allowed to select any focus area on the image file to perform focusing after shooting to generate a satisfactory picture, which implements focusing after shooting with another method, but also allowed to comprehensively form the image file to generate a picture with each of focus areas being the clearest and finally obtain a photograph having a good shooting effect and an artistic effect, so that requirements of self-determination and individual requirements of the user can be satisfied. The disclosure also allows the user to select a plurality of focus areas, and blur other areas except the focus areas, thereby obtaining photographs having special artistic effects, satisfying the user's creative demands, and greatly improving the user experience.

Referring to FIG. 5 and FIG. 6, an embodiment of an imaging device of the disclosure is proposed. The imaging device includes a receiving module 100, a shooting module 200 and a displaying module 300.

The receiving module 100 is configured to receive various instructions, including a shooting instruction and an instruction of operating an image file, and transmit various instructions to the shooting module.

The shooting instruction is triggered after a user presses a shooting button. The shooting button is a physical button or a virtual button. The instruction of operating the image file includes an instruction of performing focusing on the image file, an instruction of comprehensively forming the image file and so on. For a touch screen, the user may trigger, by a gesture of touching or clicking on the image file on the screen and so on, the instruction of performing focusing on the image file, and trigger, by a gesture of swiping on the screen, long pressing or clicking on the image file and so on, the instruction of comprehensively forming the image file. For a non-touch screen, the instruction for comprehensive forming may be triggered by a functional key or invoking a menu.

The displaying module 300 is configured to display various images, including a picture, a photograph, an image file, a preview image and so on. The displaying module 300 includes a display screen, and the display screen may be a touch screen or a non-touch screen.

The shooting module 200 is configured to shoot an image, and process various instructions. After receiving the shooting instruction, the shooting module 200 continuously shoot at least two images with at least two depths of field, forms the at least two images into an image file, and execute the instruction of operating the image file.

The image file is an image group formed by the shooting module by using a plurality of shot images and composite images thereof. The shooting module stores the image group temporarily, and selects an image or a composite image from the image group as a preview image for the user to select a focus area.

The shooting module 200 includes a processing unit 230, a camera 220 and a driving module 210, wherein

the driving unit 210 is configured to drive the camera 220 to move forwards or backwards so that the camera 220 can shoot images with at least two depths of field continuously, and

the camera 220 is configured to shoot the images continuously and shoot at least one image with each of the at least two depths of field.

The driving unit 210 includes a motor. After being calibrated, a motion parameter of the motor corresponds to a depth-of-field table of the imaging device, and the motor by a number of steps or revolutions to drive the camera 220 to move to a corresponding position so as to shoot an image with a corresponding depth of field. The number of depths of field, with which images are shot, may be adjusted as required by the user. For example, images with two depths of field, images with a plurality of depths of field, or even images with all depths of field may be shot. At least one image is shot with each of the at least two depths of field, and it may be also set to shoot two or more images as required by the user.

The processing unit 230 is configured to execute, after receiving the instruction of operating the image file, the operation instruction, wherein the operation instruction includes an instruction of performing focusing on the image file, an instruction of comprehensively forming the image file and so on.

After receiving the instruction of comprehensively forming the image file, the processing unit 230 comprehensively forms the image file, and forms all images in the image file into a picture with each of focus areas being clearest.

After receiving the instruction of performing focusing on the image file, the processing unit 230 determines a focus area on the image according to the instruction, then selects an image with the focus area being clearest from the image file, and finally generates a picture from the selected image. For a touch screen, the processing unit 230 determines a touched or clicked area of the image file as the focus area, and for a non-touch screen, the displaying module 300 displays a focus area selection pattern, and the processing unit 230 determines an area where the selection pattern locates as the focus area.

Further, the processing unit 230 may determine two or more focus areas according to selection by the user, then compares and calculates a plurality of images in the image file, and for each focus area, selects an image which is the clearest at the focus area. For example, the user selects 3 focus areas, i.e. focus area 1, focus area 2 and focus area 3, in total, then the imaging device correspondingly selects 3 images in total, i.e. image 1 which is the clearest at focus area 1, image 2 which is the clearest at focus area 2, and image 3 which is the clearest at focus area 3. Finally, the processing unit 230 forms two or more selected images into a picture which are the clearest in each focus area. The picture has a special artistic effect.

Further, the processing unit 230 may further blur other areas except the focus areas of the selected images, and then generates a picture by the resulting images, thereby displaying the image having the focus areas in a more highlighted manner and obtaining a picture having an artistic effect. The picture which is finally generated not only has a plurality of clear focus areas, but also has other blurred areas except the plurality of focus areas especially when a plurality of images are selected because a plurality of focus areas are selected, thereby displaying an image having a plurality of focus areas in a highlighted manner, and obtaining a photograph having a special artistic effect.

The imaging device may operate the image file repeatedly to generate a plurality of pictures having various effects, and may also store the image file, and invoke the image file at any time to be operated to generate a picture.

The clearest focus area in the disclosure is described in a comparative manner. For example, focus area A is determined, there are 10 images in the image file, and image 5 is the clearest in focus area A compared with other 9 images among the 10 images.

According to an imaging device of the disclosure, images with at least two depths of field are shot continuously, and the shot images are formed into an image file to be previewed by a user, then the user is not only allowed to select any focus area on the image file to perform focusing after shooting to generate a satisfactory picture, which implements focusing after shooting with another method, but also allowed to comprehensively form the image file to generate a picture with each of focus areas being the clearest and finally obtain a clear photograph having an artistic effect, so that requirements of self-determination and individual requirements of the user can be satisfied. The disclosure also allows the user to select a plurality of focus areas, and blurred other areas except the focus areas, thereby obtaining photographs having special artistic effects, satisfying the user's creative demands, and greatly improving the user experience.

Those of ordinary skill in the art may understand that all or part of the steps for implementing the methods in the embodiments above may be implemented by related hardware controlled by a program. The program may be stored in a computer-readable storage medium which may be a Read-Only Memory (ROM)/Random Access Memory (RAM), a magnetic disk, an optical disk and so on.

It should be understood that the above are only preferred embodiments of the disclosure, but are not intended to limit the patent scope of the disclosure. All variations of equivalent structures or equivalent flows made by using contents of the specification and the accompanying drawings of the disclosure or directly or indirectly applied in other related technical fields should be similarly covered in the patent protection scope of the disclosure.

### INDUSTRIAL APPLICABILITY

According to a shooting method provided by the disclosure, images with at least two depths of field are shot continuously, and the shot images are formed into an image file to be previewed by a user, then the user is not only allowed to select any focus area on the image file to perform focusing after shooting to generate a satisfactory picture, which implements focusing after shooting with another method, but also allowed to comprehensively form the image file to generate a picture with each of focus areas being the clearest and finally obtain photograph having a good shooting effect and an artistic effect, so that requirements of self-determination and individual requirements of the user can be satisfied. The disclosure also allows the user to select a plurality of focus areas, and blur other areas except the focus areas, thereby obtaining photographs having special artistic effects, satisfying the user's creative demands, and greatly improving the user experience.

1.-4. (canceled)

5. A shooting method, comprising:
upon reception of a shooting instruction, continuously shooting at least two images with at least two depths of field, and forming the at least two images into an image group;
displaying an image of or an image formed from the at least two images as a preview image for a user to select a focus area; and
determining the focus area according to an operation instruction from the user, selecting an image with the focus area being the clearest from the image group, and generating a picture from the selected image.

6. The shooting method according to claim 5, wherein the operation instruction comprises an instruction of performing focusing on the preview image, and determining the focus area according to the operation instruction from the user comprises:
taking an operation instruction of touching or clicking on the preview image by the user as the instruction of performing focusing on the preview image, and determining a touched or clicked area of the preview image as the focus area according to the instruction.

7. The shooting method according to claim 5, further comprising: after selecting the image with the focus area being the clearest from the image group, blurring other areas except the focus area of the selected image.

8. The shooting method according to claim 5, wherein there are at least two said focus areas, and accordingly, there are at least two selected images, and generating the picture from the selected image comprises:
forming the at least two selected images into a picture with each of the at least two focus areas being the clearest.

9. The shooting method according to claim 5, wherein the operation instruction comprises an instruction of performing comprehensively forming on the images, and determining the focus area according to the operation instruction from the user comprises:
upon reception of the instruction of performing comprehensively forming on the images, determining all areas covering the preview image as the focus area.

10. An imaging device, comprising a receiving module, a shooting module and a displaying module,
wherein the receiving module is configured to receive a shooting instruction and an instruction of operating an image file;
wherein the shooting module is configured to continuously shoot at least two images with at least two depths of field, form the at least two images into an image file, and generate a picture according to the instruction of operating the image file; and
wherein the displaying module is configured to display the image file.

11. The imaging device according to claim 10, wherein the imaging device comprises a processing unit, the instruction of operating the image file comprises an instruction of performing focusing on the image file, and the processing unit is configured to:
after receiving the instruction of performing focusing on the image file, determine a focus area on the image file according to the instruction;
select an image with the focus area being the clearest from the image file; and
generate a picture from the selected image.

12. The imaging device according to claim 11, wherein the processing unit is further configured to:
blurring other areas except the focus area of the selected image.

13. The imaging device according to claim 11, wherein the processing unit is configured to determine at least two focus areas, select at least two images accordingly, and form at least two selected images into a picture with each of the at least two focus areas being the clearest.

14. The imaging device according to claim 10, wherein the instruction of operating the image file comprises an instruction of comprehensively forming the image file, and the processing unit is configured to, after receiving the instruction of comprehensively forming the image file, form all images in the image file into a picture with each area being the clearest.

15. A shooting method, comprising:
upon reception of a shooting instruction, continuously shooting images with a plurality of depths of field, wherein at least one image is shot with each of the plurality depths of field;
displaying a preview image for a user to determine a focus area;
determining the focus area according to an instruction from the user;
selecting an image with the focus area being the clearest from the images; and
generating a picture according to the selected image and storing the generated picture, wherein when there is one focus area, the picture is directly generated from the selected image, and when there are a plurality of focus areas, a plurality of selected images are formed so as to generate a picture with each of the focus areas being the clearest.

16. The shooting method according to claim 15, wherein determining the focus area according to the instruction from the user comprises:
generating a focus area selecting pattern on the preview image for the user to select one or more focus areas; and
determining the focus area according to selection by the user.

17. The shooting method according to claim 15, wherein generating the picture according to the selected image further comprises:
blurring other areas except the focus area.

18. The shooting method according to claim 15, wherein determining the focus area according to the instruction from the user comprises:
upon reception of an instruction of performing comprehensively forming on the images, determining all areas covering the preview image as the focus area.
